(19) United States
(12) Patent Application Publication
(10) Pub. No.: US 2026/0210259 A1
(43) Pub. Date: Jul. 23, 2026

(54) SEALING METAL SHEET, TURBINE, BENDING TOOL, AND METHOD

(71) Applicant: Siemens Energy Global GmbH & Co. KG, Munich, Bayern (DE)

(72) Inventors: Stefan Krause, Krefeld (DE); Rayk Lagodka, Falkensee (DE); Fabian Göbel, Berlin (DE); Benjamin Runge, Zühlsdorf (DE); Fene Winkler, Berlin (DE)

(73) Assignee: Siemens Energy Global GmbH & Co. KG, Munich, Bayern (DE)

(21) Appl. No.: 19/145,931

(22) PCT Filed: Oct. 31, 2023
(86) PCT No.: PCT/EP2023/080333

§ 371 Date: Jul. 5, 2025

(30) Foreign Application Priority Data
Jan. 11, 2023 (DE) 10 2023 200 159.4

(51) Int. Cl. F01D 11/00; B21D 5/00

(52) U.S. Cl. CPC F01D 11/006; B21D 5/002; F05D 2230/54; F05D 2240/55; F05D 2260/30

(57) ABSTRACT

A sealing metal sheet for receiving a securing metal sheet which is installed during the installation of turbine blades, and which has two slots for the securing metal sheet, wherein the sealing metal sheet has a groove above the slots. A corresponding bending tool and method is provided.

### CROSS REFERENCE TO RELATED APPLICATIONS

This application is the US National Stage of International Application No. PCT/EP2023/080333 filed 31 Oct. 2023, and claims the benefit thereof, which is incorporated by reference herein in its entirety. The International Application claims the benefit of German Application No. DE 10 2023 200 159.4 filed 11 Jan. 2023.

### FIELD OF INVENTION

The invention relates to a sealing metal sheet for securing turbine blades, to a tool and to a turbine and a method.

### BACKGROUND OF INVENTION

Sealing metal sheets are attached during the installation of turbine blades into the disks, and are secured by securing metal sheets. Securing metal sheets are similar to a pointer which is wound through the sealing metal sheet in order to hold the turbine blades in their position.

FIGS. 1 and 2 each show a sealing metal sheet 10 with a securing metal sheet 20.

The sealing metal sheet 10 is preferably angular, preferably tetragonal and preferably slightly trapezoidal.

The sealing metal sheet 10 has two mutually parallel slots 11, 12 (FIGS. 1 and 2), through which the securing metal sheet 20 has been passed and then bent. The end of the securing metal sheet 20 is preferably of pointed or triangular design.

FIG. 2 shows FIG. 1 in cross section.

The reference sign 20′ shows the securing metal sheet 20 in the unbent state.

The securing metal sheet 20, as a rigid locking sheet made of metal, generally rests flat on the sealing metal sheet 10.

For removal, the securing metal sheets 20 must be bent upward through an angle 25, as illustrated in the following figure. For removal, a wedge-shaped tool is typically driven in on one side, usually by means of blows, and this can lead to damage. Currently, the securing metal sheets 20 are bent up with a screwdriver, for example, for removal. This will take place differently, depending on the fitter, and therefore the quality of the securing metal sheets 20 differs, and reinstallation and thus approval for additional operating hours are not authorized.

The securing metal sheet, together with the sealing metal sheet, is replaced with a new one, giving rise to costs.

### SUMMARY OF INVENTION

It is therefore an object of the invention to indicate a sealing metal sheet for a turbine, by means of which the problems are overcome, and to indicate a tool and a method by means of which removal takes place in a controlled manner.

The object is achieved by a sealing metal sheet, a turbine, a tool, and a method as claimed.

Additional advantageous measures, which can be combined as desired to achieve further advantages, are listed in the dependent claims.

### BRIEF DESCRIPTION OF THE DRAWINGS

In the drawings:

FIGS. 1 and 2 show a sealing metal sheet and a securing metal sheet according to the prior art,

FIG. 3 shows a sealing metal sheet according to the invention,

FIG. 4 shows a sealing metal sheet according to the invention with a securing metal sheet in the installed state,

FIGS. 5 to 9 show a bending tool in various detail views.

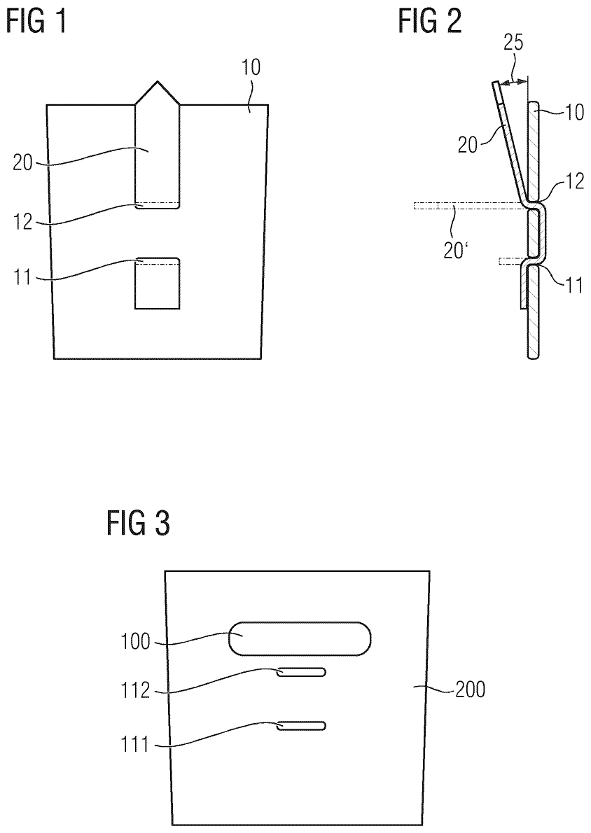

### DETAILED DESCRIPTION OF INVENTION

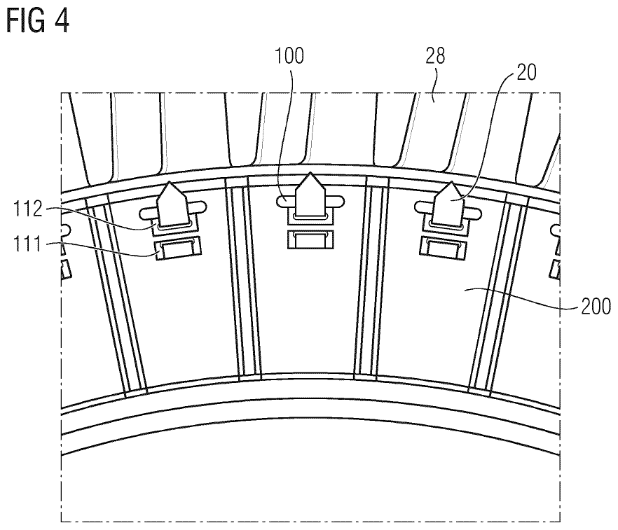

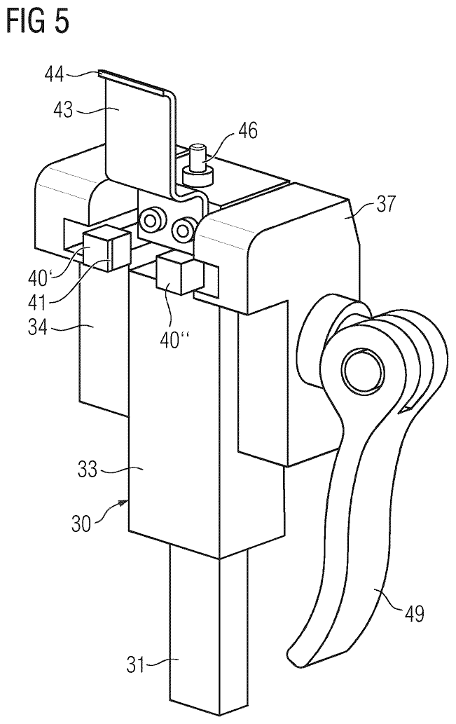

FIG. 3 shows a sealing metal sheet 200 according to the invention without a securing metal sheet, and FIG. 4 shows it in the installed state with a securing metal sheet 20 in the rotor and turbine blades 28.

In contrast to the prior art, the sealing metal sheet 200 now has a “service” groove 100 with a depth of preferably up to 50% of the thickness of the sealing metal sheet 200, which favors the use of a bending tool 30 (FIG. 5 ff) and thus allows the immediate reuse of the sealing metal sheets 200.

The groove 100 is arranged above the two slots 111, 112 (corresponding to the slots 11, 12 in the sealing metal sheet 10 according to the prior art). The groove 100 extends in the same direction as the slots 111, 112 and is designed to be wider than the slots 111, 112.

The bending up of securing metal sheets 20 is assisted by a bending tool 30 (FIG. 5 ff), thus avoiding the risk of damaging components or adjacent components.

The bending tool 30 has at least the following: a main body 33, a bending lever 31 on the main body 33, by means of which the securing metal sheet 20 is bent up, wherein the bending lever 31 preferably extends the main body 33, a, preferably fixed, clamping jaw 34 and a moving clamping jaw 37 for clamping the securing metal sheet 20, as well as a clamping lever 49 for this purpose.

Exchangeable clamping wedges 40: 40′, 40″ are preferably present both on the fixed clamping jaw 34 and on the moving clamping jaw 37. The clamping wedges 40 project beyond the main body 33.

Different clamping wedges 40 can be used for different sealing metal sheets corresponding to different turbine stages and/or different securing metal sheets 20.

Instead of this, it is likewise possible for the fixed clamping jaw 34 and the moving clamping jaw 37 to be of wedge-shaped design in order to perform the function of the clamping wedges 40.

The bending tool 30 likewise has, preferably at the distal end (opposite the bending lever 31), a bending limiter 46, by means of which the bending angle of the securing metal sheet 20 is limited, as well as a positioning aid 43.

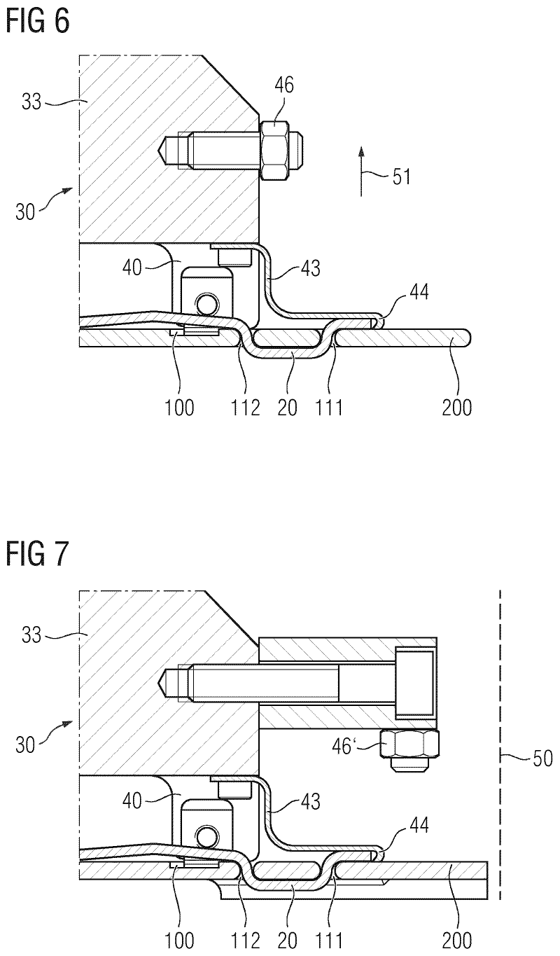

An illustrative procedure is as follows:
1) preparing the bending tool 30 for use on a particular turbine stage:
   mounting the clamping wedges 40 on the bending tool 30
   mounting the bending limiter 46 for the bending process for the respective version/application.
2) positioning:
   positioning the bending tool 30 over the securing metal sheet 20 to be bent, using the positioning aid 43, the bending tool 30 is hooked in at the free end of the securing metal sheet 20 and centered.
3) clamping:
   using the clamping lever 49, in particular by means of a screwing movement, the two clamping wedges 40 are adjusted and finally fixed, in particular by actuating the clamping lever 49. The securing metal sheet 20 is now firmly connected to the bending tool 30 by the contact pressure and the engagement of the clamping wedges 40. The clamping wedges 40 engage in the groove 100 (FIGS. 6 and 7) and rest in contact under the securing metal sheet 20 to be bent.
4) adjusting the bending angle:
   using the bending lever 31, the securing metal sheet 20 is bent up partially at one end until a sufficiently large angle a has been achieved to enable the combination of the sealing and the securing metal sheets to be removed from their retention groove.
   When the angle a is correct, the bending limiter 46 must be secured in order to prevent unwanted adjustment of the bending angles on the other (adjacent) securing metal sheets.
5) opening and removal:
   bending up further securing metal sheets 20 as far as the stop position by bending by means of the bending tool 30,
   after each securing metal sheet 20 has been bent up, a check should be made to determine whether the maximum permissible angle has been exceeded.
   If the angle has been exceeded owing to variability during bending, the bending limit must be reset, and this step must be repeated.

The method is identical for all stages of various turbines, irrespective of the embodiment of the bending limit.—bending up the remaining securing metal sheets as described above: mounting and positioning—closing the clamping lever—bending up as far as the bending limit displacing the sealing metal sheet.

The advantages are:
a standardized mode of operation conforming to safety standards, without provisional tools
no restriction due to a working position
no misuse of tools from a range of tools that are not designed for this work
rapid and simple use
defined removal with component loading as low as necessary
multiple usage of the securing metal sheets 20 together with the sealing metal sheets 200 and cost savings as a result.

The bending tool 30 is small and easy to handle and does not collide with adjacent components. The use of the bending tool 30 avoids damage and ensures straight upward bending. The bending tool 30 is positioned in such a way over the securing metal sheet 20 to be bent that the entire securing metal sheet 20 is bent in a straight line, and no additional bending radii are formed in the securing metal sheet 20. For this purpose, the bending tool 30 is placed as close as possible to the existing bending radius, close to the slot 112.

The clamping wedges 40 are of appropriately hard design, that is to say are preferably manufactured from a hardened material, thus avoiding deformation when used multiple times.

The clamping wedges 40 have a certain wedge angle, which is optimized for the different thicknesses and lengths of the securing metal sheets 20.

The clamping wedges 40 which are used for bending the securing metal sheets 20 have a low surface roughness.

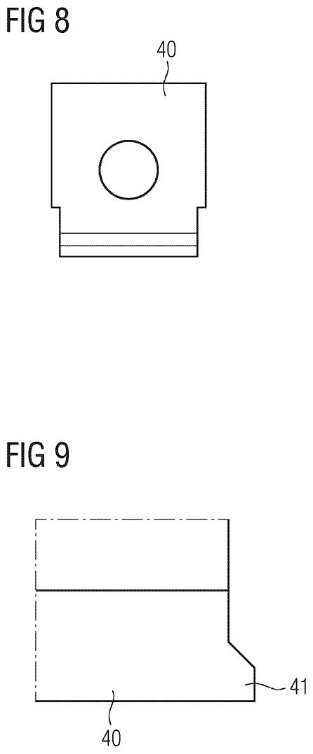

An illustrative clamping wedge 40 is illustrated in FIG. 8 (plan view) and 9 (cross-sectional detail).

The wedge-shaped ends 41 of the clamping wedges 40 are blunt to ensure that the cutting edge of the wedge 40 does not break under high loads.

To adapt the bending tool 30 to the different widths of the securing metal sheets 20, spacer plates can be mounted between the clamping wedges 40 and the clamping jaws.

The resilient positioning aid 43 is used to position the bending tool 30 in such a way that the axis of rotation and the bending axis are aligned with one another. During the positioning of the bending tool 30, the resilient positioning aid 43 is brought into contact with the blunt end of the securing metal sheet 20. For the bending process, the resilient positioning aid 43 is designed in such a way that it is rigid in one direction, such that the axis of rotation and the bending axis are aligned with one another, and is elastic in the other direction, such that it is not deformed plastically during the bending of the securing metal sheet 20.

The axis of rotation and the bending axis must be aligned in such a way that there is linear contact between the clamping wedge 40 and the securing metal sheet 20. Damage both to the securing metal sheet 20 and to the clamping wedges 40 is thereby avoided. The clamping wedges 40 themselves are positioned close to the already existing bend in the securing metal sheet in order to prevent the securing metal sheet from acquiring an additional bend.

In FIG. 6, it can be seen how the clamping wedge 40 rests in the groove 100 in the sealing metal sheet 200, and the resilient positioning aid 43 rests against the end of the securing metal sheet 20.

The resilient positioning aid 43 is S-shaped and is fastened by means of a first portion on the main body 33 of the bending tool 30. A second portion, which extends in an axial direction 51, has a length such that the following third portion comes to rest flat on the securing metal sheet 20 and engages by means of a cutting edge 44 around one end of the securing metal sheet 20 on the sealing metal sheet 200.

To prevent the user from bending the securing metal sheet 20 excessively, there is a bending limiter 46, 46′ (FIG. 7). This is a mechanical limiter, which enters into interaction with the rotor of the turbine in a particular direction.

This can be a threaded pin (FIG. 6) which is locked by means of a nut, is connected to the main body 33 of the bending tool 30, and is fixed by a locknut.

Alternatively, use is made of an adapter (FIG. 7), which then makes stop contact with the rotor (line 50) during application.

In both variants 46, 46′, the position of the bending limiter 46, 46′ is adjustable and can be fixed for the subsequent sealing metal sheets. Therefore, the bending limiter need only be adjusted once at the beginning.

1. A sealing metal sheet, for receiving a securing metal sheet, which is installed during installation of turbine blades, comprising:
two slots for the securing metal sheet, and
a groove above the slots.

2. The sealing metal sheet as claimed in claim 1,
wherein the groove is designed to be wider than the two slots, and/or wider than the securing metal sheet to be bent, thereby enabling wedges of a bending tool to rest fully therein before they clamp the securing metal sheet.

3. The sealing metal sheet as claimed in claim 1, wherein the groove has a depth of up to 50% in the sealing metal sheet.

4. A turbine, comprising:
at least one stage comprising turbine blades in a rotor disk, and
the sealing metal sheets as claimed in claim 1, which are installed on the rotor disk.

5. A bending tool, for bending a securing metal sheet, comprising:
a main body,
wherein the main body comprises two clamping jaws for receiving the securing metal sheet.

6. The bending tool as claimed in claim 5, further comprising:
a fixed clamping jaw,
a moving clamping jaw, and
a clamping lever for clamping the clamping jaws.

7. The bending tool as claimed in claim 5, further comprising:
exchangeable clamping wedges on the clamping jaws,
wherein the exchangeable clamping wedges have an end which, in an installed state of the bending tool, are engageable under the securing metal sheet in a groove in a sealing metal sheet.

8. The bending tool as claimed in claim 5, further comprising:
a positioning aid for resting against a sealing metal sheet.

9. The bending tool as claimed in claim 8,
wherein the positioning aid has a cutting edge, which is engageable around one end of a securing metal sheet.

10. The bending tool as claimed in claim 5, further comprising:
a bending limiter.

11. A method, comprising:
removing a securing metal sheet from a sealing metal sheet,
wherein a the bending tool as claimed in claim 5 is used for bending the securing metal sheet.

12. The method as claimed in claim 11, further comprising:
positioning clamping wedges under the securing metal sheet,
positioning the bending tool relative to the securing metal sheet by a resilient positioning aid,
fixing the securing metal sheet by a clamping lever, and
bending up the securing metal sheet by moving a bending lever.

13. The method as claimed in claim 11, further comprising:
arranging a positioning aid on the securing metal sheet.

14. The sealing metal sheet as claimed in claim 2,
wherein the sealing metal sheet comprises only one groove.

15. The bending tool as claimed in claim 5,
wherein the securing metal sheet is arranged on a sealing metal sheet.

16. The bending tool as claimed in claim 5,
wherein the two clamping jaws comprise a fixed clamping jaw and a moving clamping jaw.

17. The bending tool as claimed in claim 8,
wherein the positioning aid comprises a resilient positioning aid.

18. The method as claimed in claim 11,
wherein the sealing metal sheet is adapted for receiving a securing metal sheet which is installed during installation of turbine blades, and which comprises two slots for the securing metal sheet and a groove above the slots.
